(19) United States
(12) Patent Application Publication
(10) Pub. No.: US 2024/0329312 A1
(43) Pub. Date: Oct. 3, 2024

(54) SPLICE-ON FIBER OPTIC CONNECTOR ASSEMBLY

(71) Applicant: CommScope Technologies LLC, Hickory, NC (US)

(72) Inventors: Michael Lawrence Gurreri, York, PA (US); Yu Lu, Eden Prairie, MN (US); Mark O. Vogel, Statesville, NC (US); Christopher Paul Gemme, Hickory, NC (US)

(21) Appl. No.: 18/621,636

(22) Filed: Mar. 29, 2024

Related U.S. Application Data
(60) Provisional application No. 63/493,374, filed on Mar. 31, 2023.

(51) Int. Cl. G02B 6/255

(52) U.S. Cl. CPC G02B 6/2555

(57) ABSTRACT

A fiber optic connection system is disclosed. The fiber optic connection system includes a pre-terminated fiber optic connector assembly adapted to be optically spliced to a fiber optic cable at a splice location. A robust splice protection package configured for field installation is adapted to be installed over the splice location.

### CROSS REFERENCE TO RELATED APPLICATIONS

This application claims priority to U.S. Provisional Patent Application No. 63/493,374, filed Mar. 31, 2023 the disclosure of which is incorporated herein by reference in its entirety.

### TECHNICAL FIELD

The present disclosure relates generally to fiber optic connectors.

### BACKGROUND

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288 and 8,556,520.

It will be appreciated that a number of different types of ruggedized fiber optic connectors are available for outside environmental use. International Publication No. WO2015/028433 discloses a system for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter. Other systems are disclosed by PCT International Publication Nos. WO2021/041305 and WO2020/236512.

Splice-on fiber optic connectors are known. A typical splice-on fiber optic connector includes an optical fiber including a first fiber portion that is supported in a ferrule and second fiber portion (e.g., a fiber stub) that projects rearwardly from the ferrule. The second fiber portion is spliced (e.g., mechanically or by a fusion splice) to the optical fiber of a fiber optic cable. In one type of splice-on connector, the splice location is positioned within the fiber optic connector (e.g., see U.S. Pat. Nos. 9,016,953 and 10,281,649). In another type of splice-on connector, the splice location is located outside the fiber optic connector in a separate protective package (e.g., see U.S. Pat. Nos. 11,016,258 and 8,885,998). There is a need for splice-on connectors having features that facilitate performing splicing in the field.

### SUMMARY

One aspect of the present disclosure relates to a fiber optic connection system including a pre-terminated fiber optic connector assembly including a fiber optic connector terminating a front end of a first fiber optic cable, the first fiber optic cable including a first optical fiber; and a second fiber optic cable including a second optical fiber that is optically spliced to the first optical fiber at a splice location between a rear end of the first fiber optic cable and a front end of the second fiber optic cable. The fiber optic connection system also includes a sealing housing having opposite first and second ends, the sealing housing being adapted to be installed over the splice location with the first fiber optic cable extending through the first end of the sealing housing and the second fiber optic cable extending through the second end of the sealing housing. The fiber optic connection system further includes a cable anchoring component for maintaining an axial spacing between the rear end of the first fiber optic cable and the front end of the second fiber optic cable, the cable anchoring component including a first cable anchoring portion adapted to be secured to a strength member and/or cable jacket of the first fiber optic cable, the cable anchoring component including a second cable anchoring portion adapted to be secured to a strength member and/or cable jacket of the second fiber optic cable, and the cable anchoring component including an axial reinforcing member that extends axially between the first and second cable anchoring portions and across the splice location. The cable anchoring component is installable with respect to the first and second cables to maintain the axial spacing between the rear end of the first fiber optic cable and the front end of the second fiber optic cable before the sealing housing is positioned over the splice location. Also, the sealing housing being slidable over the cable anchoring component after the cable anchoring component has been installed with respect to the first and second cables to maintain the axial spacing between the rear end of the first fiber optic cable and the front end of the second fiber optic cable.

Another aspect of the present disclosure relates to a fiber optic connection system including: a pre-terminated fiber optic connector assembly including a fiber optic connector terminating a front end of a first fiber optic cable, the first fiber optic cable including a first optical fiber; and a second fiber optic cable including a second optical fiber that is optically spliced to the first optical fiber at a splice location between a rear end of the first fiber optic cable and a front end of the second fiber optic cable. The fiber optic connection system also includes a sealing housing having opposite first and second ends, the sealing housing being adapted to be installed over the splice location with the first fiber optic cable extending through the first end of the sealing housing and the second fiber optic cable extending through the second end of the sealing housing. The fiber optic connection system further includes end sealing assemblies for sealing the first and second ends of the sealing housing, each of the end sealing assemblies including: a fastener for coupling to one of the first and second ends of the sealing housing; an elastomeric sealing member; and an end cap for directing axial load from the fastener to the corresponding elastomeric sealing members. The fiber optic connection system additionally includes cable locks that mount within the sealing housing, the cable locks being configured to clamp on strength members and/or jackets of the first and second fiber optic cables, the cable locks having outer tapers that nest with respect to inner tapers defined within the sealing housing by the sealing housing, wherein when the fasteners are coupled to the sealing housing the elastomeric sealing member are axially compressed between the end caps and the cable locks thereby causing the elastomeric sealing members to radially deform and provide sealing, and wherein when the fasteners are coupled to the sealing housing the outer tapers of the cable locks are forced against the inner tapers of the sealing housing causing the cable locks to clamp on the strength members and/or jackets of the first and second fiber optic cables.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 depicts a fiber optic connector assembly prepared for optical splicing to an optical fiber of a fiber optic cable;

FIG. 2 depicts the fiber optic connector assembly of FIG. 1 optically spliced to the fiber optic cable;

FIG. 3 depicts the fiber optic connector assembly of FIG. 2 with a splice protector installed over the optical splice between the fiber optic connector assembly and the fiber optic cable;

FIG. 4 depicts the fiber optic connector assembly of FIG. 3 with a cable anchoring and sealing assembly installed over the splice location; first

FIG. 5 depicts various components of the cable anchoring and sealing assembly arranged in a pre-assembled state;

FIG. 6 depicts a cable anchoring component of the cable anchoring and sealing assembly positioned to extend across the splice location;

FIG. 7 depicts the cable anchoring component secured to an end of the fiber optic cable as well as an end of a cable stub corresponding to the fiber optic connector assembly;

FIG. 8 depicts an outer sealing housing of the cable anchoring and sealing assembly installed over the splice location;

FIG. 9 is a cross-sectional view depicting an example sealing arrangement for sealing opposite ends of the outer sealing housing;

FIG. 10 depicts another splice-on fiber optic connector and fiber optic cable assembly in accordance with the principles of the present disclosure;

FIG. 11 is a cross-sectional view of an example cable anchoring and sealing assembly in accordance with the principles of the present disclosure for protecting a splice location of the splice-on fiber optic connector and cable assembly of FIG. 10;

FIG. 12 is a perspective view of an example sealing assembly of the cable anchoring and sealing assembly of FIG. 11 configured for sealing a flat cable such as the flat drop cable depicted at FIG. 30;

FIG. 13 is another perspective view of the sealing assembly of FIG. 12;

FIG. 14 is an exploded view of the sealing assembly of FIGS. 12 and 13;

FIG. 15 is a cross-sectional view of the sealing assembly of FIGS. 12 and 13;

FIG. 16 is another cross-sectional view of the sealing assembly of FIGS. 12 and 13;

FIG. 17 is a perspective view of a cable anchoring component of the cable anchoring and sealing assembly of FIG. 11 configured for anchoring a flat cable such as the flat drop cable depicted at FIG. 30;

FIG. 18 is another perspective view of a cable anchoring component of FIG. 17;

FIG. 19 is an end view of the cable anchoring component of FIGS. 17 and 18 in a closed state;

FIG. 20 is an end view of the cable anchoring component of FIGS. 17 and 18 in a partially open state;

FIG. 21 is an opposite end view of the cable anchoring component of FIGS. 17 and 18 in the partially open state;

FIG. 22 is a side view of an outer housing of the cable anchoring and sealing assembly of FIG. 11;

FIG. 23 is a perspective, end view depicting one of the ends of the outer housing of FIG. 22;

FIG. 24 depicts a first step for assembling the cable anchoring and sealing assembly of FIG. 11;

FIG. 25 depicts a second step for assembling the cable anchoring and sealing assembly of FIG. 11;

FIG. 26 depicts a third step for assembling the cable anchoring and sealing assembly of FIG. 11;

FIG. 27 is a first view of alternative cable anchoring and sealing components in accordance with the principles of the present disclosure configured for anchoring and sealing a round cable such as the round cable depicted at FIG. 31;

FIG. 28 is a second view of the cable anchoring and sealing components of FIG. 27;

FIG. 29 is a cross-sectional view of the cable anchoring and sealing components of FIGS. 27 and 28 assembled at the end of an outer housing;

FIG. 30 is a cross-sectional view of an example flat cable;

FIG. 31 is a cross-sectional view of an example round cable;

FIG. 32 is a cross-sectional view of an example shape memory (e.g., heat-shrink) splice protector;

FIG. 33 is a cross-sectional view of an example fiber optic connector that can be part of fiber optic connection systems in accordance with the principles of the present disclosure;

FIG. 34 depicts a pre-assembly for a splice arrangement in accordance with the principles of the present disclosure; and

FIG. 35 depicts an example mechanical fiber alignment device that can be used with splice arrangements in accordance with the principles of the present disclosure.

### DETAILED DESCRIPTION

Aspects of the present disclosure relate to splice-on connector solutions. In certain examples, the splice-on connector solutions can relate to a field-installable product having a factory terminated connector that can be spliced to a fiber optic cable in the field. In certain examples, the field-installable product can include a field installable, hardened splice protection package located outside of the factory terminated connector. In certain examples, the factory terminated connector can be factory terminated to a fiber optic cable stub having an optical fiber adapted to be optically spliced to a corresponding optical fiber of a fiber optic cable in the field. In certain examples, the optical splice can include a fusion splice or a mechanical splice. In certain examples, the hardened splice protection package can be referred to as a hardened splice joint or a cable sealing and anchoring assembly. In a preferred example, the optical splice is provided at the end of a cable stub (i.e., a fiber optic cable pigtail) to which the fiber optic connector is pre-terminated such that the splice location is offset from the fiber optic connector by a length of the cable stub. By offsetting/separating the splice location from the fiber optic connector, splice-on configurations in accordance with the principles of the present disclosure are not necessarily connector dependent (i.e., can be used with a variety of different connector types) and do not require the redesign or requalification of existing connectors. In certain examples, the splice-on solution can be used with different types of fusion splicers, cleavers and fiber strippers from different vendors and also can be used for mechanical splices. In certain examples, the splice-on solution is applicable for both single fiber and multi-fiber fiber optic connector applications. In certain examples, the splice-on solution can include different configurations designed for different cable constructions thereby providing enhanced modularity. In certain examples, aspects of the present disclosure relate to splice-on solutions that are relatively simple to implement in the field at relatively low cost.

FIGS. 1-4 illustrate an example fiber optic connection system 20 in accordance with the principles of the present disclosure. The fiber optic connection system 20 includes a pre-terminated connector assembly 22 adapted to be optically spliced to a fiber optic cable 24 with the optical splice being protected by a field installable, splice protection package 26. The pre-terminated connector assembly 22 includes a fiber optic connector 28 and a stub fiber optic cable 30 terminated (e.g., factory terminated) by the fiber optic connector 28. The stub fiber optic cable 30 includes an optical fiber 204a having a front end supported by the fiber optic connector 28 and a rear end adapted to be spliced to a corresponding optical fiber 204b of the fiber optic cable 24 at a splice location 25. The splice protection package 26 includes a cable anchoring and sealing assembly having a cable anchoring component 36 for axially fixing an end of the fiber optic cable 24 relative to the rear end of the stub fiber optic cable 30, an outer sealing housing 38 for covering the cable anchoring component 36 and the optical splice location 25, and end sealing assemblies 40 sealing opposite ends of the outer sealing housing 38 relative to the fiber optic cable 24 and the stub fiber optic cable 30. FIGS. 1-4 depict a sequence of steps for connecting the pre-terminated connector assembly 22 to the fiber optic cable 24.

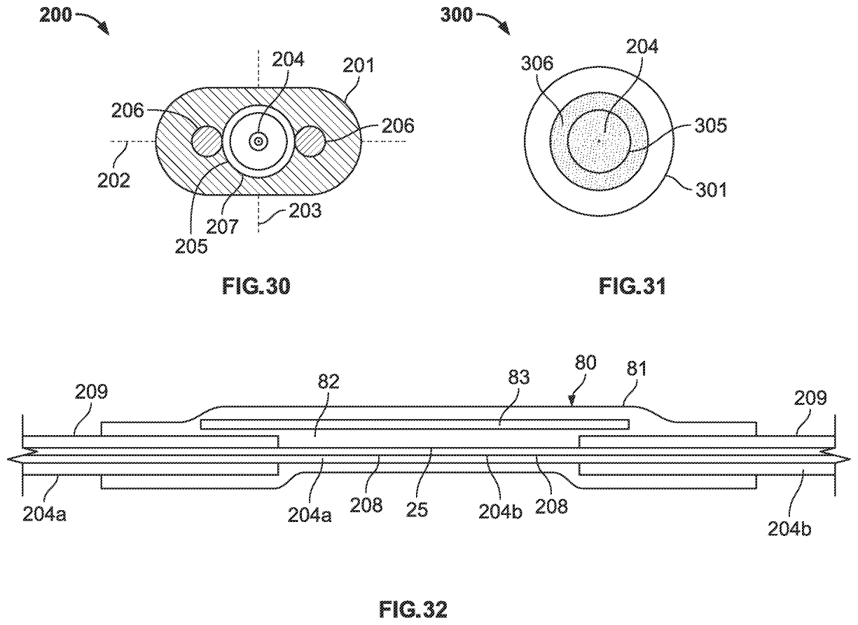

For the fiber optic connection system 20 of FIGS. 1-4, the stub fiber optic cable 30 and the fiber optic cable 24 are depicted having a flat cable configuration 200 as depicted at FIG. 30. The flat cable configuration 200 includes a cable jacket 201 having an elongate cross-sectional profile that is longer along a major axis 202 as compared to a minor axis 203. The flat cable configuration 200 includes a central passage 207 containing an optical fiber 204. A protective layer such as a buffer tube 205 can surround the optical fiber 204. The central passage 207 can be positioned between strength members such as reinforcing rods 206 (e.g., glass fiber reinforced polymeric rods). The central passage 207 and the reinforcing rods 206 can be positioned along the major axis 202. In an alternative example, the stub fiber optic cable 30 and the fiber optic cable 24 can have a round cable configuration 300 as depicted at FIG. 31. The round cable configuration 300 includes a cable jacket 301 having a round cross-sectional profile. An optical fiber 204 can be located at a central position within the cable jacket 301 and can optionally be protected by a protective layer such as a buffer tube 305. Strength members such as aramid yarns 306 can be positioned within the cable jacket 301. In the depicted example, the aramid yarns 306 are positioned to surround the optical fiber 204 and are positioned between the buffer tube 305 and the cable jacket 301.

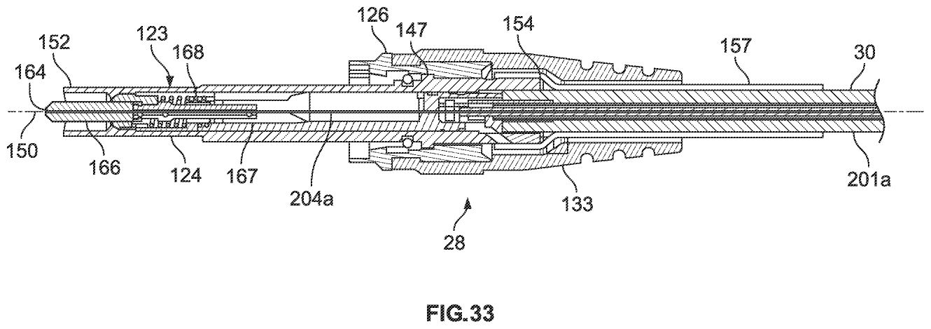

Referring to FIG. 33, the fiber optic connector 28 includes a connector core 123 having a connector core housing 124 that is elongated along a length that extends along a longitudinal axis 150. The connector core housing 124 includes a front plug end 152 positioned opposite from a rear cable attachment end 154. The front plug end 152 optionally has a form factor compatible with an SC type fiber optic adapter; but could have other form factors as well such as an LC connector form factor compatible with an LC fiber optic adapter. The stub fiber optic cable 30 is attached or secured to the connector core 123 at the rear cable attachment end 154 of the connector core housing 124. For example, strength members 206a of the stub fiber optic cable 30 can be attached to the connector core 123 at the rear cable attachment end 154 by adhesive (e.g., epoxy), crimping or other means.

The stub fiber optic cable 30 includes an outer jacket 201a. The outer jacket 201a of the stub fiber optic cable 30 can be secured to the rear cable attachment end 154 of the connector core housing 124 by a sleeve 157 such as a shape memory sleeve (e.g., a heat-shrink sleeve) and additionally by adhesive injected within the connector core housing 124. In certain examples, the heat-shrink sleeve can include an interior layer of adhesive for bonding the heat-shrink sleeve to the outer jacket 201a and to the connector core housing 124. A turn-to-secure coupler 126 is mounted over the connector core housing 124 and can be turned (e.g., rotated) relative to the connector core housing 124 about the longitudinal axis 150. The turn-to-secure coupler 126 is captured axially between an outer stop 147 (e.g., a shoulder) of the connector core housing 124 and the front end of the sleeve 157 such that the coupler 126 is axially retained on the connector core housing 124. The fiber optic connector 28 includes a boot 133 for providing bend radius protection to the stub fiber optic cable 30. In one example, the turn-to-secure coupler 126 positioned within the boot 133 and the boot 133 optionally can be turned in unison with the coupler 126 about the longitudinal axis 150. The turn-to-secure coupler 126 can be configured for coupling the fiber optic connector 28 to a variety of different structures such as converter housings, fiber optic adapters, dust caps, or other structures (e.g., sec PCT International Publication Number WO 2021/041305 which is hereby incorporated by reference in its entirety).

The optical fiber 204a of the stub fiber optic cable 30 is routed longitudinally through the outer jacket 201a of the stub fiber optic cable 30 and through the fiber optic connector 28. A front end portion of the optical fiber 204a is routed through a ferrule 166 positioned at the front plug end 152. The front end portion of the optical fiber 204a defines a fiber tip 164 at the front plug end 152 of the connector core housing 124. The front end portion of the optical fiber 204a is secured and supported within the ferrule 166. The ferrule 166 is spring biased in a forward direction relative to the connector core housing 124 by a spring 168. An inner body 167 mounts within the connector core housing 124 and includes a front end that functions as a spring stop and a rear end that can include a structure for use in securing strength members of the stub fiber optic cable 30 to the connector core 123.

A rear end 42 of the stub fiber optic cable 30 can be prepared (e.g., factory prepared) to be ready for field splicing. For example, the rear end 42 of the stub fiber optic cable 30 can be pre-prepared by stripping, cleaving, and cleaning the rear end 42 of the stub fiber optic cable 30. A temporary protective package can be installed over the rear end 42 at the factory to protect the pre-prepared portion of the stub fiber optic cable 30 until it is ready to be used in the field.

The fiber optic cable 24 can include a cable jacket 201b, the optical fiber 204b and strength members 206b (shown in FIG. 4). During preparation of the ends of the cables 24, 30 for splicing, the cable jackets 201 can be stripped to expose lengths of the optical fibers 204 and the strength members 206. The strength members 206 can be cut to a length that projects beyond the ends of the stripped cable jackets but is shorter than the lengths of the optical fibers 204. The optical fibers 204 can each include a bare fiber portion 208 including a glass core surrounded by a glass cladding, and a coating layer 209 (e.g., a polymeric coating such as acrylate). The coating layer 209 can be stripped from the ends of the optical fibers 204 to expose the bare fiber portions 208. The exposed bare fiber portions 208 can be cleaved and cleaned so as to be ready for splicing. It will be appreciated that the end of the fiber optic cable 24 can be cut, stripped, cleaved and cleaned in the field. This allows the fiber optic cable 24 to be cut to length in the field to minimize the amount of excess cable needed to be stored adjacent the connection location.

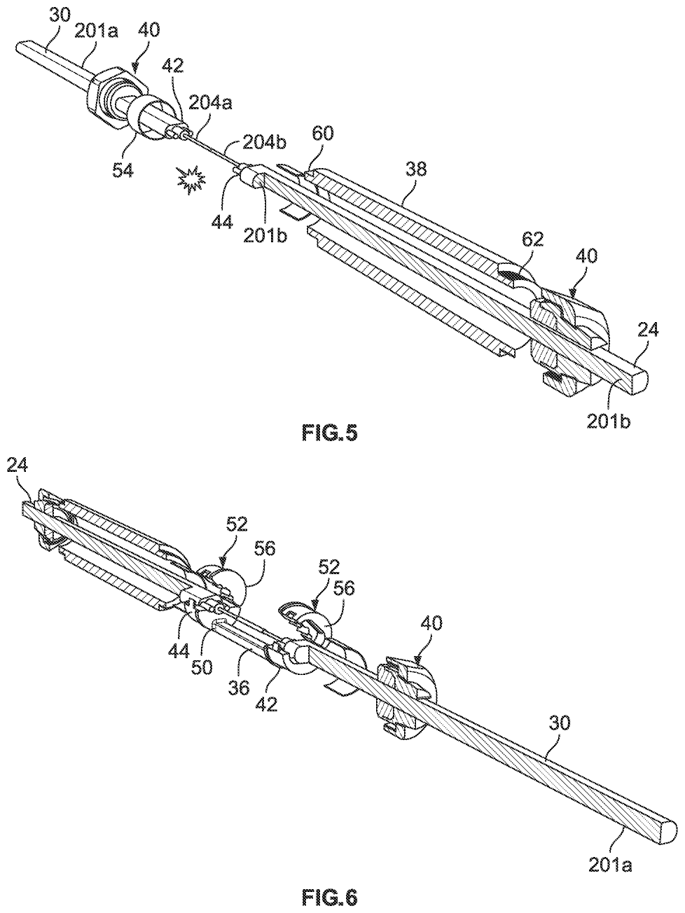

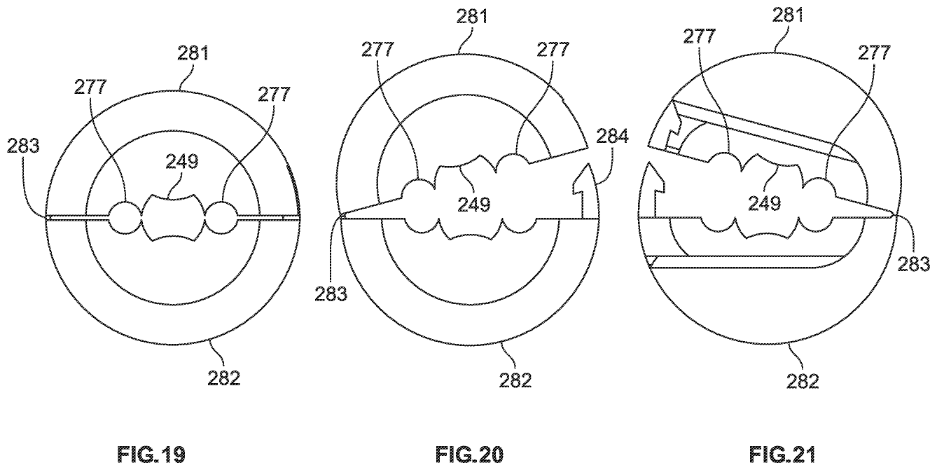

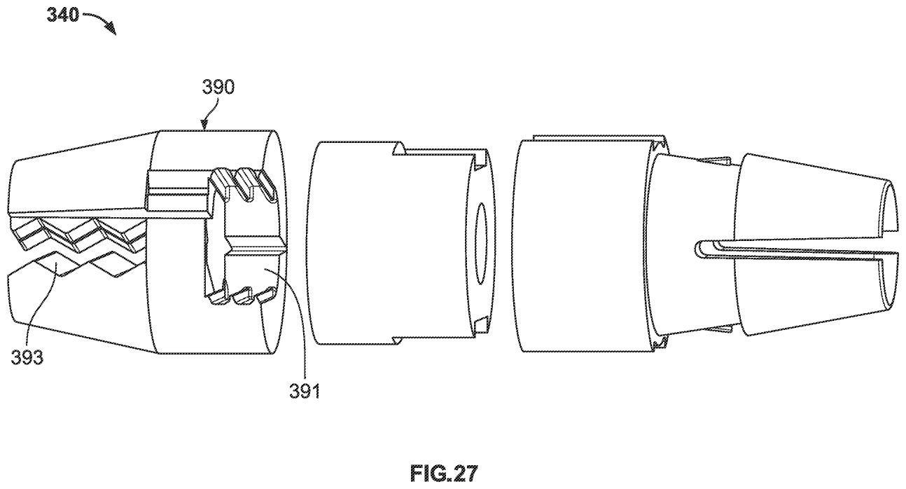

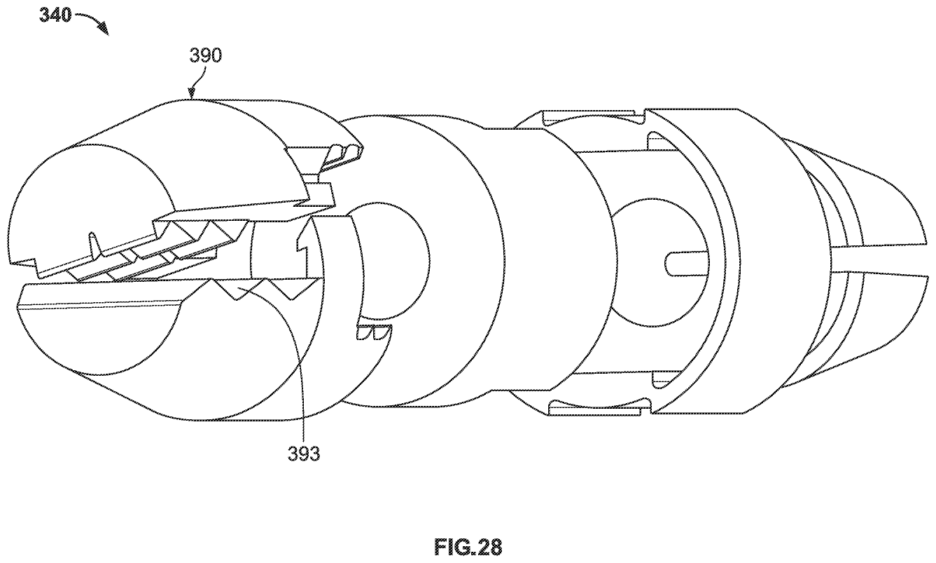

The cable anchoring component 36 is adapted to axially fix the rear end 42 of the stub fiber optic cable 30 relative to a front end 44 of the fiber optic cable 24. The cable anchoring component 36 can be referred to as a mechanical splint, a mechanical bridge, a mechanical anchor, a structural support member or like terms. The cable anchoring component 36 is configured to traverse the splice location 25 and to prevent axial movement between the front end 44 of the fiber optic cable 24 and the rear end 42 of the stub fiber optic cable 30. The cable anchoring component 36 can be configured to convey axial load across the splice location 25 such that axial load is prevented from being applied to the splice location 25. In certain examples, the cable anchoring component 36 can include an axial reinforcing member 50 (shown in FIG. 6) that extends across the splice location 25 and cable anchoring structures 52 (shown in FIG. 6) connected to the axial reinforcing member 50. The cable anchoring structures 52 can be configured to couple to the rear end 42 of the stub fiber optic cable 30 and the front end 44 of the fiber optic cable 24. The cable anchoring structures 52 can be configured to couple to the strength members 206a, 206b (shown in FIG. 4) of the fiber optic cables 24, 30 and/or the cable jackets 201a, 201b of the fiber optic cables 24, 30. In certain examples, the cable anchoring structures 52 can be secured to the fiber optic cables 24, 30 by structures including mechanical crimps such as crimp sleeves 54. In certain examples, the cable anchoring structures 52 can include clamping structures that clamp on the strength members and/or the cable jackets of the fiber optic cables 24, 30. In the depicted example, the cable anchoring structures 52 include cable clamps 56 (shown in FIG. 6) that are secured to the strength members 206a, 206b and/or the cable jackets 201a, 201b with the assistance of the crimp sleeves 54 (shown in FIG. 5) which retain the cable clamps 56 and a clamped orientation. In the depicted example, the cable clamps 56 are unitarily formed with the axial reinforcing member 50 and are positioned at opposite ends of the axial reinforcing member 50. In certain examples, the cable clamps 56 can have a clamshell configuration of the type depicted at FIGS. 17-21. As depicted, the cable clamps 56 are adapted for clamping strength members such as rod-type string members. In other examples, the cable clamps 56 can be configured for clamping alternative strength members such as aramid yarn (e.g., see an example configuration for clamping aramid yarns at FIGS. 27 and 28). In certain examples, the cable anchoring component 36 can slide or axially float within and relative to the outer sealing housing 38 at least prior to installation of the end sealing assemblies 40. The cable anchoring component 36 can be secured to the fiber optic cables 24, 30 prior to installation of the outer sealing housing 38 over the splice location 25. Thus, the cable anchoring component 36 can be installed on the fiber optic cables 24, 32 fix the relative axial positions of the ends of the fiber-optic cables 24, 30 prior to the outer sealing housing 38 being positioned over the splice location 25.

The outer sealing housing 38 is adapted to protect and provide environmental sealing with respect to the splice location 25. In the depicted example, the outer sealing housing 38 is depicted as a sleeve (e.g., a tubular sleeve). In one example, the outer sealing housing 38 has a unitary molded plastic one-piece construction. The outer sealing housing 38 has opposite first and second ends 60, 62 at which the fiber-optic cables 24, 30 respectively enter the outer sealing housing 38 and are respectively sealed with respect to the outer sealing housing 38. The outer sealing housing 38 can include exterior threads 64 at each of the first and second ends 60, 62 for mechanically interfacing with the end sealing assemblies 40.

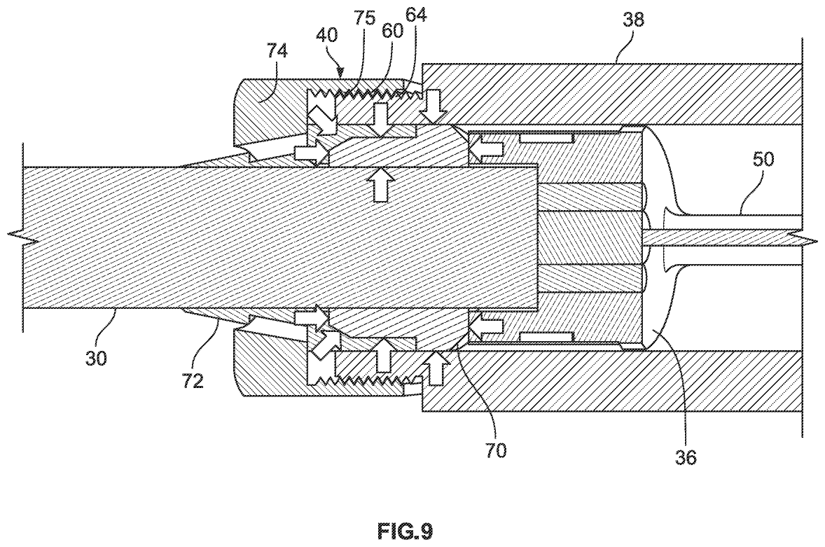

Referring to FIG. 9, the end sealing assemblies 40 each include an elastomeric sealing member 70, an end cap 72 and a fastener 74. The elastomeric sealing member 70 can have an internal cross-sectional profile that matches the outer cross-sectional profile of the respective one of the fiber optic cables 24, 30 being sealed. The elastomeric sealing member 70 can have an outer cross-sectional profile that matches an inner cross sectional profile of the outer sealing housing 38. In the depicted example, the fastener 74 is configured as a nut having internal threads 75 adapted to engage the exterior threads 64 at the end of the outer sealing housing 38. While a threaded connection is preferred because of the range of axial movement provided, it will be appreciated that other types of connections such as snap-fit connections, bayonet-style connections, quarter turn connections can also be used. The end cap 72 is assembled on the respective cable 24, 30 axially between the elastomeric sealing member 70 and the fastener 74. When the fastener 74 is threaded on the end of the outer sealing housing 38, the end cap 72 is forced axially against the elastomeric sealing member 70 to cause axial compression load to be applied to the elastomeric sealing member 70. During sealing of the ends of the outer sealing housing 38, the cable anchoring component 36 is axially compressed between the end sealing assemblies 40. Compressive load for compressing the elastomeric sealing members 70 is transferred axially through the cable anchoring component 36. The compressive load applied to the cable anchoring component 36 limits axial movement of the cable anchoring component 36 within the outer sealing housing 38. The application of axial compression load to the elastomeric sealing members 70 (as the elastomeric sealing member 70 are axially compressed between their respective end cap 72 and the adjacent end of the cable anchoring component 36 during tightening of the fasteners 74) causes the elastomeric sealing member 70 to radially deform and provide radial sealing with respect to the interior of the outer sealing housing 38 and the exteriors of the cable jackets of the fiber optic cables 24, 30.

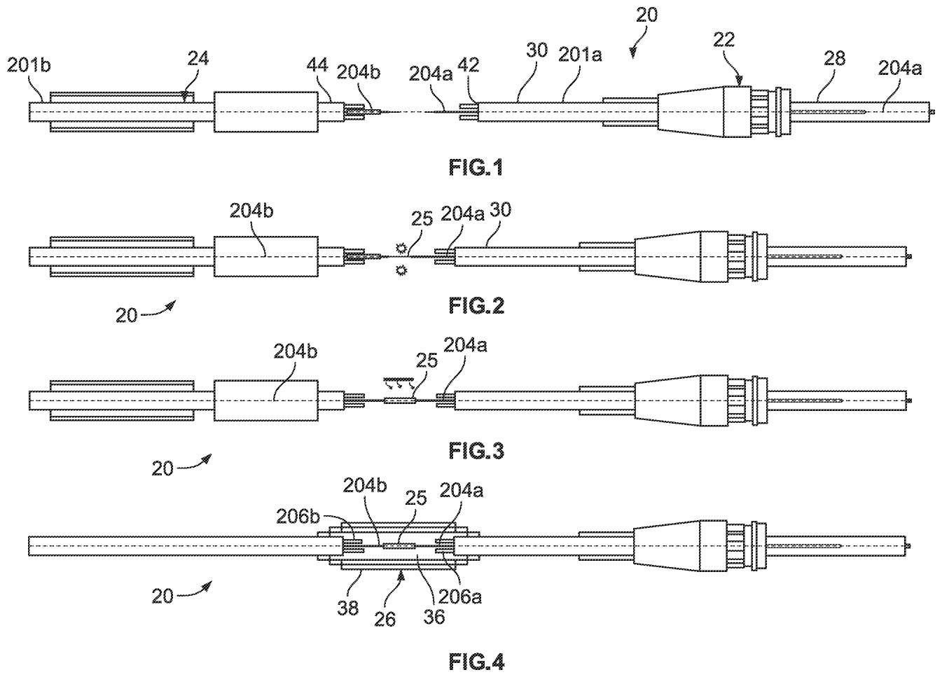

FIGS. 1-4 depict a simplified sequence of steps for connecting the pre-terminated connector assembly 22 to the fiber-optic cable 24. At FIG. 1, the rear end 42 of the stub fiber optic cable 30 and the front end 44 of the fiber optic cable 24 are shown aligned with one another. Preferably, prior to alignment, the rear end 42 of the stub fiber optic cable 30 and the front end 44 of the fiber optic cable 24 have been prepared for splicing (e.g., stripped, cleaved and cleaned). Preferably, the prepared ends of the fiber optic cables 24, 30 are configured to fit within a splice machine for fusion splicing (see FIG. 2) of the optical fiber 204a of the stub fiber optic cable 30 to the optical fiber 204b of the fiber optic cable 24 at the splice location 25. After splicing, an inner splice protection package 80 can be installed over the splice location 24 as shown at FIG. 3. Referring to FIG. 32, the inner splice protection package 80 can include a shape memory sleeve 81 (e.g., a heat-shrink sleeve) containing heat activated adhesive 82 and a reinforcing rod 83 that extends across the splice location 25. The shape memory sleeve 81 can bond to the optical fibers 204a, 204b and can coincide with bare fiber portions of the optical fibers 204a, 204b at which the splice location 25 is located and also portions of the coated fibers. After installation of the inner splice protection package 80, the cable anchoring component 36 can be secured to the ends of the fiber optic cables 24, 30 and the outer sealing housing 38 can subsequently be installed over the cable anchoring component 36 and the splice location 25. The end sealing assemblies 40 can be installed at the ends of the outer sealing housing 38 to fix the cable anchoring component 36 axially within the outer sealing housing 38 and to provide sealing between the fiber optic cables 24, 30 and the outer sealing housing 38.

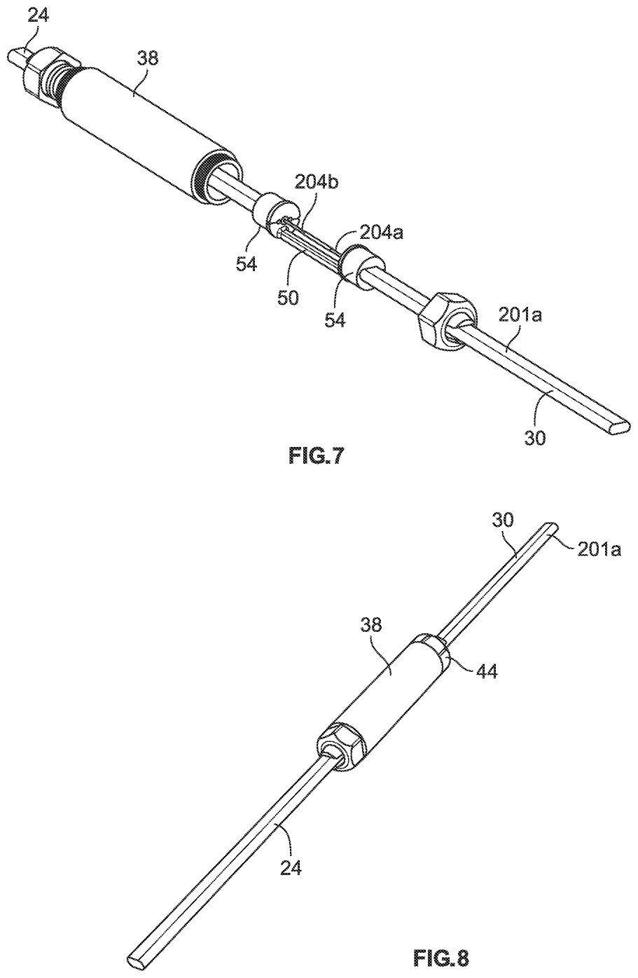

FIGS. 5-8 depict in more detail the assembly process for connecting the pre-terminated connector assembly 22 to the fiber optic cable 24. As shown at FIG. 5, prior to splicing, the end sealing assemblies 40, the outer sealing housing 38, the inner splice protection package 80 (shown in FIG. 32) and the crimp sleeves 54 are loaded onto the fiber-optic cables 24, 30. Thereafter, the optical fibers 204a, 204b are optically spliced together thereby establishing a desired spacing between the ends of the fiber optic cables 24, 30. The interior splice package 80 is then slid over the splice location 25 and heat-shrunk to provide initial protection of the splice location 25. The cable anchoring component 36 is then positioned as shown at FIG. 6 with the axial reinforcing member 50 extending across the splice location 25 (e.g., across the gap between the ends of the fiber-optic cables 24, 30) and with end portions of the fiber optic cables 24, 30 positioned within the cable anchoring structures 52. The cable anchoring structures 52 can have a wrap-around configuration that allows the cable anchoring structures 52 to be installed over their respective cables 24, 30 after splicing without requiring the cable anchoring structures 52 to be pre-installed over the cables 24, 30. The crimp sleeves 54 are then slid over the cable anchoring structures 52 (see FIG. 7) and mechanically crimped on the cable anchoring structures 52 to secure (e.g., clamp) the cable anchoring structures 52 to their respective cables 24, 30 and to retain the cable anchoring structures 52 in the secured state.

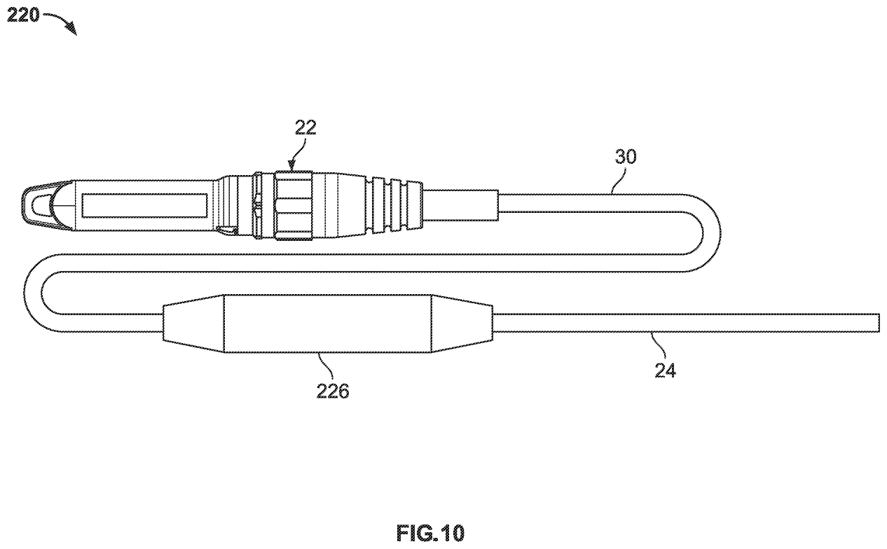

FIG. 10 depicts an alternative fiber-optic connection system 220 including an alternative splice protection package 226 for protecting the splice 25 between the pre-terminated connector assembly 22 and the fiber optic cable 24.

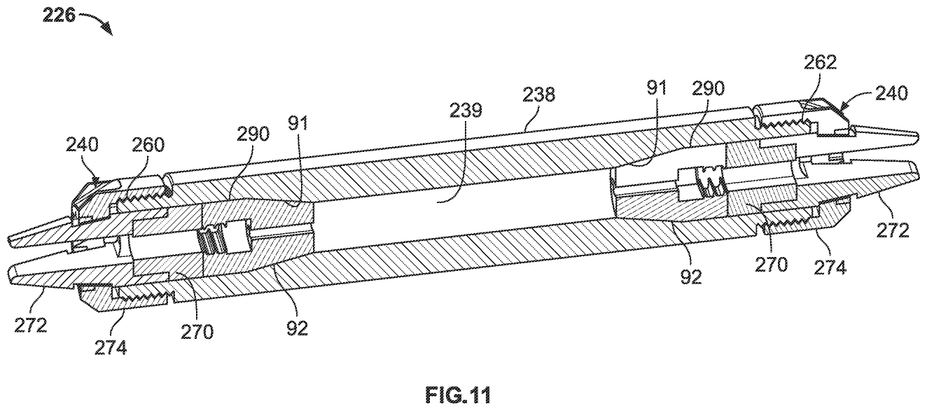

Referring to FIG. 11, the splice protection package 226 includes an outer sealing housing 238 having opposite first and second ends 260, 262. End sealing assemblies 240 are respectively mounted at each of the first and second ends 260, 262 of the outer sealing housing 238. Cable locks 290 mount within the interior of the outer sealing housing 238 for fixing ends of the fiber-optic cables 24, 30 at axial positions within the outer sealing housing 238. An interior of the outer sealing housing 238 defines tapered regions 91 that nest with corresponding tapered regions 92 of the cable locks 290 to cause radial compression of the cable locks 290 as the cable locks are forced axially inwardly within the outer sealing housing 238 toward a mid-region 239 of the outer sealing housing 238. It will be appreciated that the splice location 25 is adapted to be housed within the mid-region 239 of the outer sealing housing 238. It will be appreciated that the tapered regions 91 include tapered surfaces that constrict or converge as the tapered surfaces extend toward the mid-region 239. Similarly, the tapered regions 92 of the cable locks 290 includes surfaces that converge as the surfaces extend toward the mid-region 239 when the cable locks 290 are installed in the outer sealing housing 238.

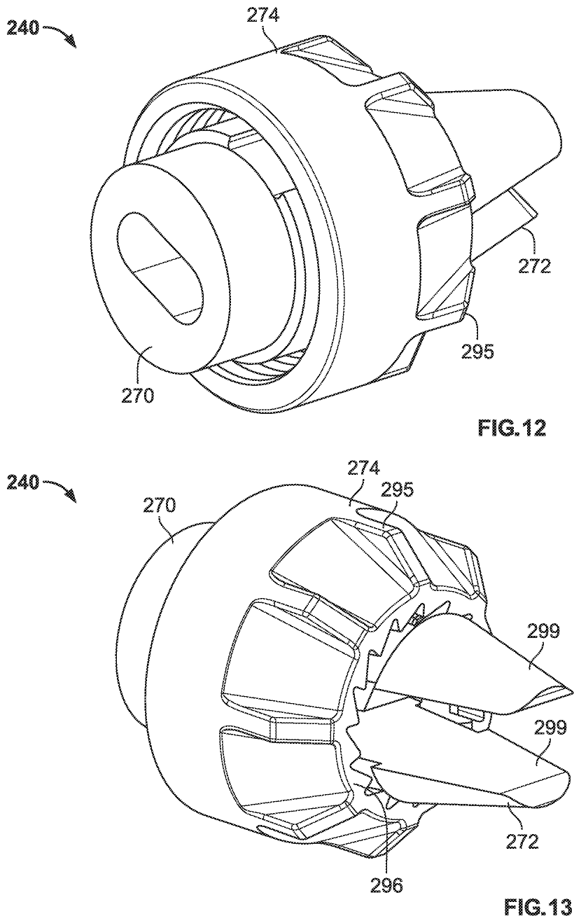

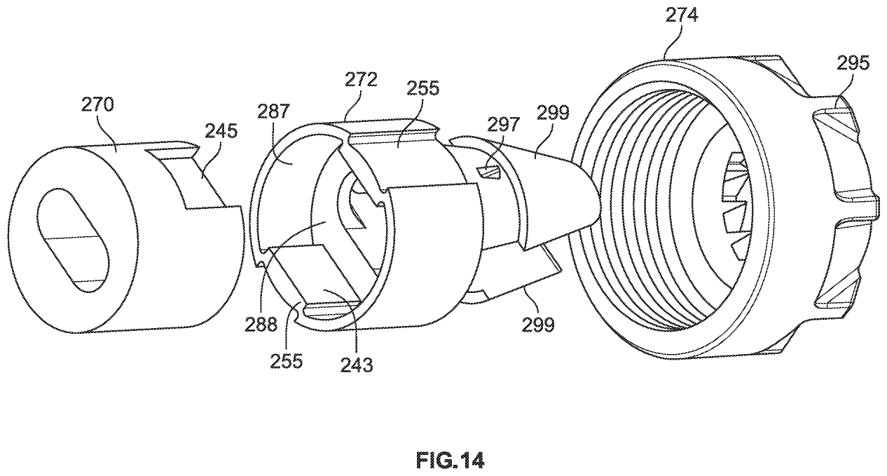

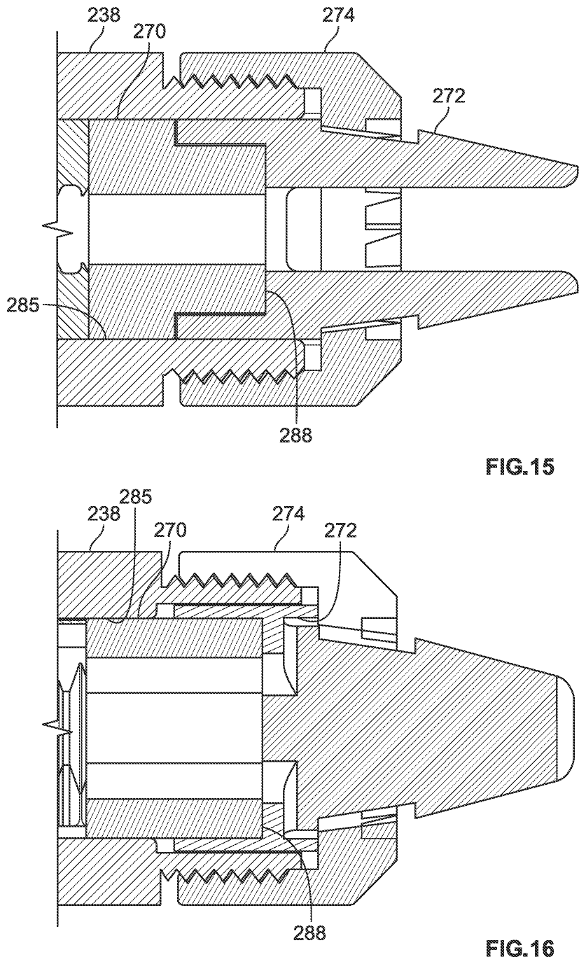

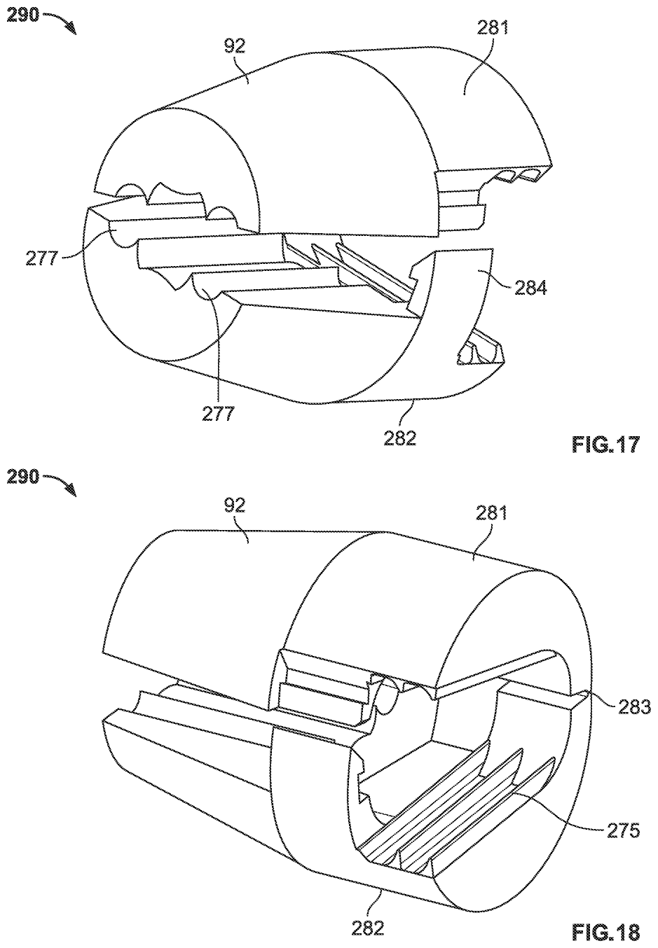

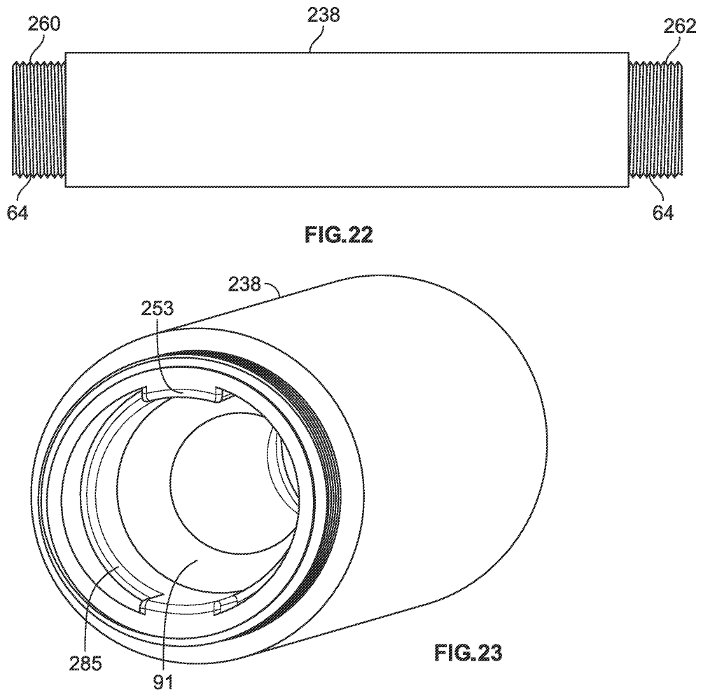

Referring to FIGS. 12-16, the end sealing assemblies 240 each include a fastener 274 adapted to be secured to a respective one of the first and second ends 260, 262 of the outer sealing housing 238, an elastomeric sealing member 270 and an end cap 272. In the depicted example, the fasteners 274 are rotational fasteners such as threaded members (e.g., nuts) having internal threads adapted to engage corresponding external threads 64 (see FIG. 22) at the first and second ends 260, 262 of the outer sealing housing 238. In other examples, the fasteners 274 can be alternative type of rotational fasteners (e.g., quarter turn fasters, bayonet-style fasteners) or can be snap-fit connectors. The end caps 272 are configured to transfer axial load from the fasteners 274 to the elastomeric sealing members 270 when the fasteners 274 are engaged with the ends of the outer sealing housing 238. The fasteners 274 can be pre-assembled on the end caps 272 and can be snapped onto the end caps 272 to prevent the fasteners 274 from being separated from the end caps 272 in transit. The fasteners 274 are configured to be able to rotate relative to the end caps 272 to allow the fasteners 274 to be threaded onto the outer sealing housing 238 without rotating the end caps 272. The fasteners 274 can include outer gripping structures 295 (e.g., ribs, recesses, projections, etc.) for facilitating manually turning the fasteners 274. A ratchet arrangement can be provided between the fasteners 274 and their corresponding end caps 272 to prevent back turning (e.g., one-way turning for tightening only) of the fasteners 274 relative to the end caps 272 and the outer sealing housing 238. For example, the fasteners 274 can include ratchet teeth 296 that engage pawls 297 on the end caps 272. The end caps 272 can be keyed relative to the outer sealing housing 238 and can have a mechanical interface with respect to the outer sealing housing 238 that prevents relative rotation between the end caps 272 and the outer sealing housing 238. The elastomeric sealing members 270 can also be keyed relative to the end caps 272 and can have a mechanical interface with respect to the end caps 272 that prevents relative rotation between the elastomeric sealing members 270 and the end caps 272. The end caps 272 can include outer tabs 299 adapted to provide cable strain relief. The elastomeric sealing members 270 can include a cross-sectional profile having an internal shape that matches an outer profile of the cable desired to be sealed by the elastomeric sealing members 270. The cross-sectional profile of the elastomeric sealing members can also include an outer shape that matches an inner shape defined by inner sealing surfaces 285 (see FIG. 23) of the outer sealing housing 238. At least portions of the elastomeric sealing members 270 can be received within pockets 287 of the end caps 272 and the end caps 272 can include internal shoulders 288 that axially oppose outer ends of the elastomeric sealing members 270. In certain examples, keys 253 within the outer sealing housing 238 can fit within keying notches 255 of the end caps 272. Also, keys 243 within the end caps 272 can fit within keying notches 245 defined by the elastomeric sealing members 270.

When the end sealing assemblies 240 are installed at the first and second ends 260, 262 of the outer sealing housing 238, engagement (e.g., threading) of the fasteners 274 with respect to the ends of the outer sealing housing 238 drives the end caps 272 axially inwardly thereby causing the elastomeric sealing members 270 to be axially compressed between the end caps 272 and the cable locks 290. Axial compression of the elastomeric sealing members 270 causes the elastomeric sealing members 270 to radially deform thereby providing sealing about their respective cables 24, 30 as well as with the inner sealing surfaces 285 of the outer sealing housing 238. Engagement of the fasteners 274 with the ends 260, 262 of the outer sealing housing 238 concurrently causes the tapered regions 92 of the cable locks 290 to be driven into the tapered regions 91 of the outer sealing housing 238 thereby causing the cable locks 290 to be radially compressed and clamped onto their corresponding cables 24, 30.

FIGS. 17-21 depict the cable lock 290 which is configured for clamping and anchoring a cable having a flat cable configuration such as the flat cable configuration 200 of FIG. 30. The cable lock 290 has a clam-shell configuration which allows the cable lock 290 to be wrapped-around the cable. The cable lock 290 has first and second pieces 281, 282 between which the cable can be clamped. The first and second pieces 281, 282 can be connected by a hinge 283 and can be secured together by a latch 284. The cable lock 290 has features for anchoring strength members of the cable as well as the jacket of the cable. For example, teeth 275 can be provided for cable jacket retention and grooves 277 can be provided for clamping strength members such as rod-type strength members (e.g., glass reinforced polymeric rods). A central portion 249 of the cable lock 290 can be configured to clamp upon the buffer tube of the cable being clamped to provide a fiber-lock function in which the optical fiber is locked within the buffer tube.

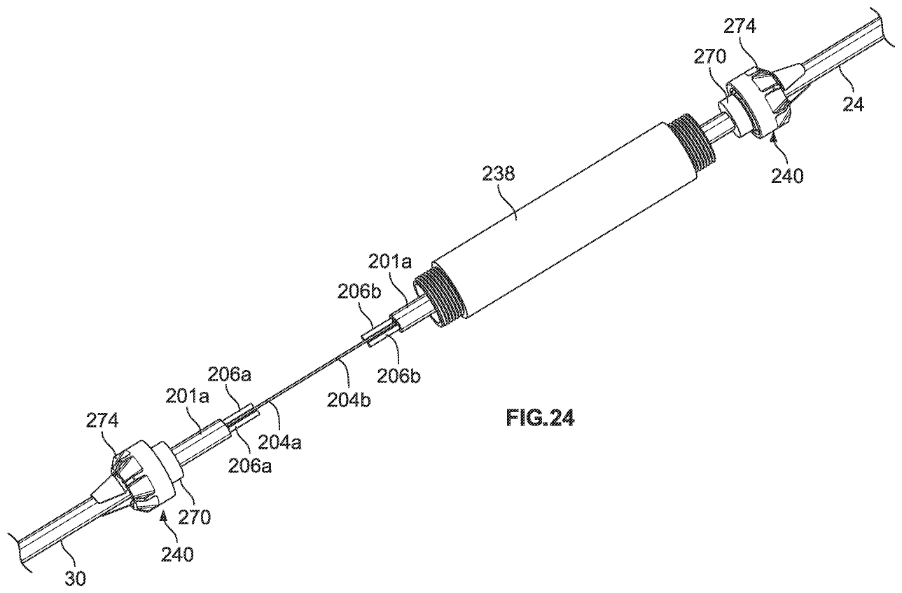

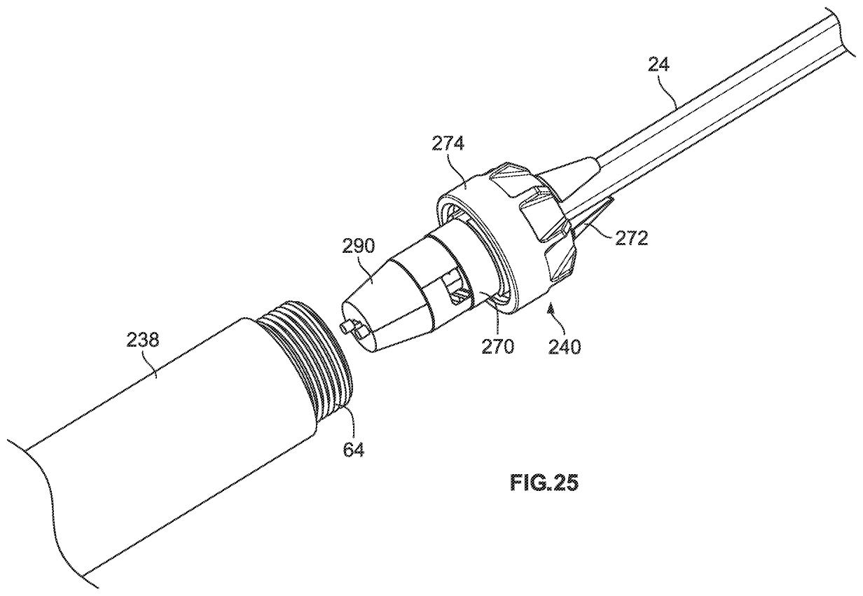

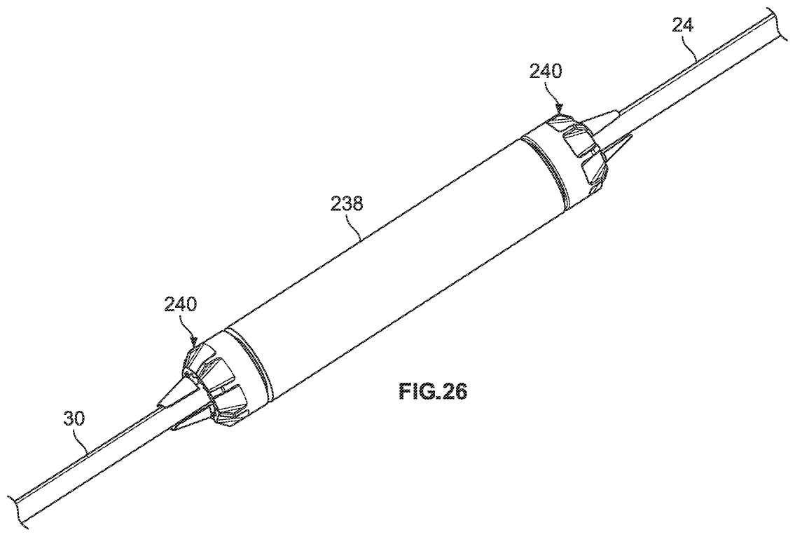

FIGS. 24-26 depict an example assembly process for assembling the fiber-optic connection system to 20. Referring to FIG. 24, the outer sealing housing 238 and the end sealing assemblies 240 are initially assembled on the fiber-optic cables 24, 30. The optical fibers 204a, 204b are then spliced together and optionally can be protected by an internal splice package which had been preassembled over the fibers. After splicing, one of the cable locks 290 is installed over one of the fiber-optic cables 24, 30 and the assembly is pushed into one end of the outer sealing housing 238 as shown at FIG. 25. The fastener 274 corresponding to the inserted cable lock 290 and inserted and end sealing assembly 240 is then threaded onto the respective end of the outer sealing housing 238 thereby causing the cable lock 290 to clamp the corresponding fiber optic cable and also causing the elastomeric sealing member 270 provide radial sealing within the outer sealing housing 238 and around the fiber-optic cable. Once the first end sealing assembly 240 has been installed, the other cable lock 290 is installed on the other one of the fiber-optic cables and the cable lock 290 as well as the corresponding end sealing assembly 240 is inserted into the opposite end of the outer sealing housing 238. The fastener 274 corresponding to the second end sealing assembly 240 is then tightened on the corresponding end of the outer sealing housing 238 to lock the second cable in place, to seal the second cable with respect to the outer sealing housing 238 and to complete the assembly process (see FIG. 26).

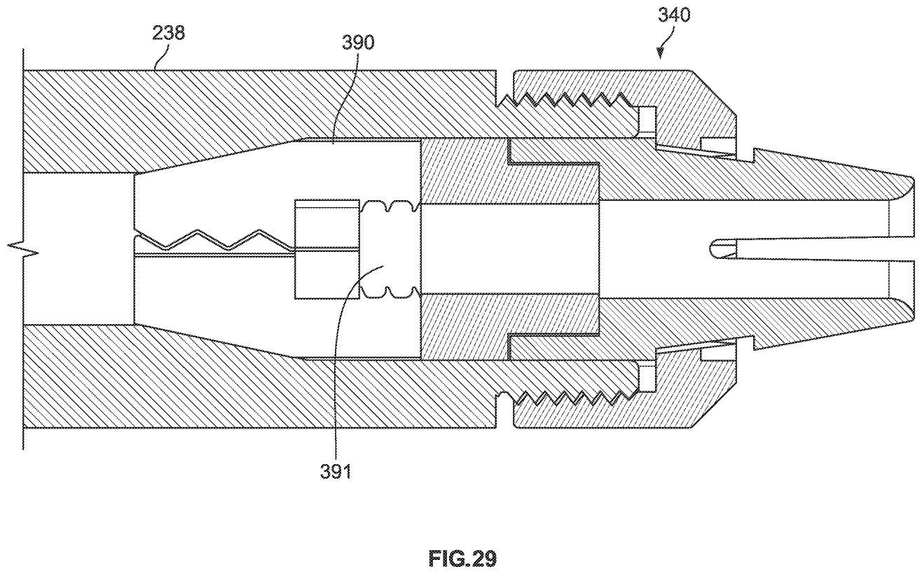

FIGS. 27-29 depict an alternative cable lock 390 and end sealing assembly 340 in accordance with the principles of the present disclosure. The cable lock 390 has a similar configuration as the cable lock 290, except the cable lock 390 has an inner shape configured to accommodate a round cable configuration such as the round cable configuration 300 depicted at FIG. 31. For example, the cable lock 390 can include a round inner pocket 391 for receiving the cable jacket 301 and can include wave-shaped clamping region 393 adapted for clamping aramid yarn 306. The end sealing assembly 340 has a similar configuration as the end sealing assembly 240, except the end sealing assembly 340 has an internal profile size and shape to correspond to the round shape of the cable jacket 301.

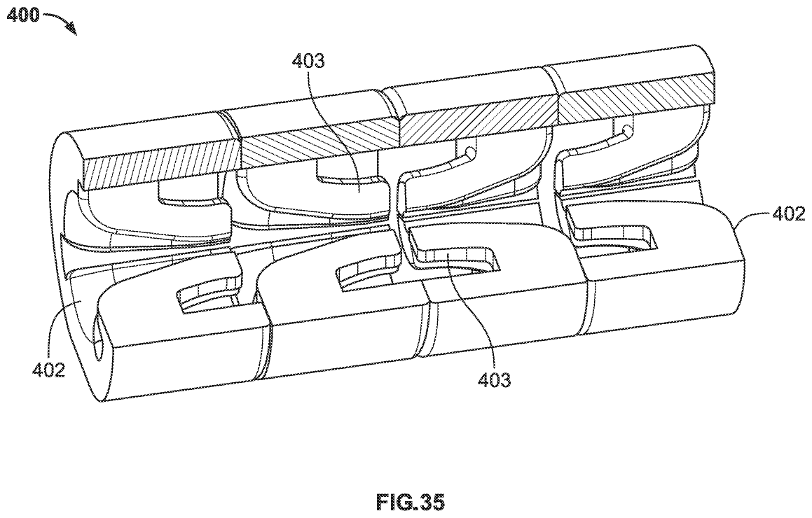

In certain examples, either of the fiber optic connection systems 20, 120 can incorporate a mechanical splice arrangement including fiber alignment device for mechanically co-axially aligning the stub optical fiber with the cable optic fiber and for retaining such alignment without the need for fusing the optical fibers together. FIG. 35 discloses an example configuration for a mechanical fiber alignment device 400 that can be integrated into connection systems in accordance with the principles of the present disclosure. The fiber alignment device includes tapered lead-ins 402 at opposite ends for receiving the front end of the cable fiber and the rear end of the stub optical fiber and resilient beams 403 for centering (i.e., co-axially aligning) the optical fibers relative to each other. Further details about example fiber alignment devices such as the fiber alignment device 400 and other example fiber alignment device configurations are described and shown by PCT International Publication No. WO2018/037078, which is hereby incorporated by reference in its entirety. In certain examples, the fiber alignment device 400 (e.g., a mechanical splice device) can contain an index matching gel and can also include adhesive for retaining the optical fibers within the fiber alignment device 400.

To facilitate the use of the fiber optic connection systems 20, 120 in the field, certain components can be pre-assembled in the factory or otherwise prior to delivery in the field. For example, with respect to the fiber optic connection system 20, the rear end of the stub fiber optic cable 30 can be factory prepared by stripping, cleaving and cleaning the rear end of the optical fiber 204a, and the cleaved rear end of the optical fiber 204a can be factory installed in the fiber alignment device 400. A protective cap or package can be used to cover all or portions of the fiber alignment device 400 to prevent dust or other contaminants from entering the fiber alignment device 400. In certain examples, the set of parts for sealing the stub fiber optic cable 30 relative to the outer sealing housing 38 (e.g., the corresponding fastener 74, the end cap 72 and the elastomeric sealing member 70) can be factory installed on the stub fiber optic cable. In certain examples, the fiber alignment device 400 can be secured to the cable anchoring component 36. In such an example, the cable anchoring component 36 can be connected to the rear end of the stub fiber optic cable 30 in the factory. Thus, in the field, and installer would prepare the optical fiber 204b, slide the set of parts for sealing the fiber optic cable 24 relative to the outer sealing housing 38 (e.g., the corresponding fastener 74, the end cap 72 and the elastomeric sealing member 70) onto the fiber optic cable 24, slide the outer housing onto the fiber optic cable 24, remove the protective structure from the fiber alignment device 400, insert the prepared optical fiber 204b into the fiber alignment device 400 to create a mechanical splice between the optical fibers 204a, 204b, anchor the fiber optic cable 24 to the cable anchoring component 36, slide the outer sealing housing 38 over the alignment device and the cable anchoring component 36, and then seal the ends of the outer housing.

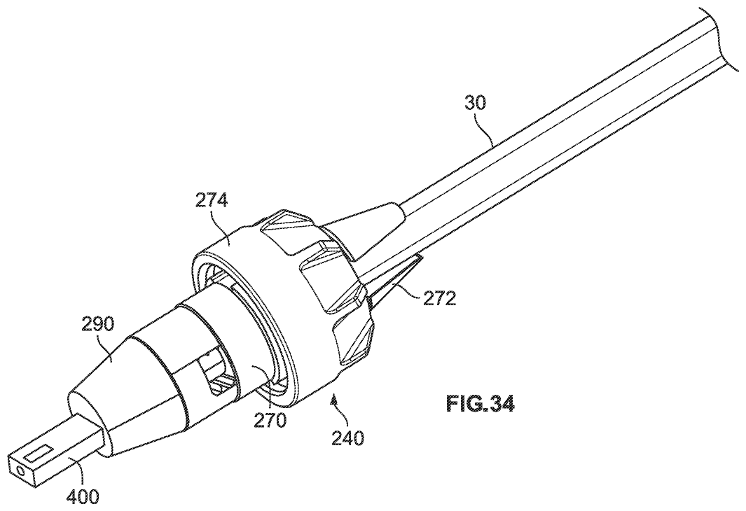

With respect to the fiber optic connection system 120, the rear end of the stub fiber optic cable 30 can be factory prepared by stripping, cleaving and cleaning the rear end of the optical fiber 204a, and the cleaved rear end of the optical fiber 204a can be factory installed in the fiber alignment device 400 (see FIG. 34). A protective cap or package can be used to cover all or portions of the fiber alignment device 400 to prevent dust or other contaminants from entering the fiber alignment device 400. In certain examples, the set of parts for sealing the stub fiber optic cable 30 relative to the outer sealing housing 238 (e.g., the corresponding fastener 274, the end cap 272 and the elastomeric sealing member 270) can be factory installed on the stub fiber optic cable 30 (see FIG. 34). In certain examples, the fiber alignment device 400 can be secured to the cable lock 290 which corresponds to and is factory installed on the stub fiber optic cable 30. In the field, and installer would prepare the optical fiber 204b, slide the set of parts for sealing the fiber optic cable 24 relative to the outer sealing housing 38 (e.g., the corresponding fastener 274, the end cap 272 and the elastomeric sealing member 270) onto the fiber optic cable 24, slide the outer sealing housing 238 onto the fiber optic cable 24, remove the protective structure from the fiber alignment device 400, insert the prepared optical fiber 204b into the fiber alignment device 400 to create a mechanical splice between the optical fibers 204a, 204b, slide the outer sealing housing 238 over the fiber alignment device 400 and then install the sealing and cable anchoring components (e.g., cable locks 290, fasteners 274, end caps 272 and elastomeric sealing members 270) at the ends of the outer sealing housing 238.

In the depicted examples, the fiber optic connector 28 is a single-fiber optical connector that is optically spliced to a single-fiber fiber optic cable. In alternative examples, the fiber optic connector 28 can be a multi-fiber connector having multiple optical fibers that are spliced to multiple optical fibers of a multi-fiber optical cable. In the depicted example, the fiber optic cable 24 and the stub fiber optic cable 30 have the same configuration. In other examples, the fiber optic cable 24 and the stub fiber optic cable 30 can have different configurations (e.g., one can be flat and the other can be round).

What is claimed is:

1. A fiber optic connection system comprising:
a pre-terminated fiber optic connector assembly including a fiber optic connector terminating a front end of a first fiber optic cable, the first fiber optic cable including a first optical fiber;
a second fiber optic cable including a second optical fiber that is optically spliced to the first optical fiber at a splice location between a rear end of the first fiber optic cable and a front end of the second fiber optic cable;
a sealing housing having opposite first and second ends, the sealing housing being adapted to be installed over the splice location with the first fiber optic cable extending through the first end of the sealing housing and the second fiber optic cable extending through the second end of the sealing housing;
a cable anchoring component for maintaining an axial spacing between the rear end of the first fiber optic cable and the front end of the second fiber optic cable, the cable anchoring component including a first cable anchoring portion adapted to be secured to a strength member and/or cable jacket of the first fiber optic cable, the cable anchoring component including a second cable anchoring portion adapted to be secured to a strength member and/or cable jacket of the second fiber optic cable, and the cable anchoring component including an axial reinforcing member that extends axially between the first and second cable anchoring portions and across the splice location; and
the cable anchoring component installable with respect to the first and second cables to maintain the axial spacing between the rear end of the first fiber optic cable and the front end of the second fiber optic cable before the sealing housing is positioned over the splice location, and the sealing housing being slidable over the cable anchoring component after the cable anchoring component has been installed with respect to the first and second cables to maintain the axial spacing between the rear end of the first fiber optic cable and the front end of the second fiber optic cable.

2. The fiber optic connection system of claim 1, wherein the first and second cable anchoring portions are configured to clamp on the strength members and/or the cable jackets.

3. The fiber optic connection system of claim 1, wherein the first and second cable anchoring portions are configured to be secured on the strength members and/or the cable jackets by crimp bands.

4. The fiber optic connection system of claim 1, further comprising heat shrink component mounted over the splice location, the heat shrink component including a heat shrink sleeve containing adhesive and a reinforcing rod.

5. The fiber optic connection system of claim 1, further comprising end sealing assemblies for sealing the first and second ends of the sealing housing.

6. The fiber optic connection system of claim 5, wherein the end sealing assemblies apply compression load to the cable anchoring component such that the cable anchoring component is compressed between the end sealings assemblies.

7. The fiber optic connection system of claim 6, wherein the end sealing assemblies force the cable anchoring component to a centered position within the sealing housing.

8. The fiber optic connection system of claim 6, wherein each of the end sealing assemblies includes a fastener for coupling to one of the first and second ends of the sealing housing, an elastomeric sealing member and an end cap for directing axial load from the fastener to the corresponding elastomeric sealing member.

9. The fiber optic connection system of claim 8, wherein the elastomeric sealing members have cross-sectional shapes with internal profiles that match external profiles of the cable jackets.

10. The fiber optic connection system of claim 8, wherein the elastomeric sealing members are compressed between the end caps and the cable anchoring component.

11. The fiber optic connection system of claim 8, wherein a threaded engagement interface is defined between the fasteners and the first and second ends of the sealing housing.

12. A fiber optic connection system comprising:
a pre-terminated fiber optic connector assembly including a fiber optic connector terminating a front end of a first fiber optic cable, the first fiber optic cable including a first optical fiber;
a second fiber optic cable including a second optical fiber that is optically spliced to the first optical fiber at a splice location between a rear end of the first fiber optic cable and a front end of the second fiber optic cable;
a sealing housing having opposite first and second ends, the sealing housing being adapted to be installed over the splice location with the first fiber optic cable extending through the first end of the sealing housing and the second fiber optic cable extending through the second end of the sealing housing;
end sealing assemblies for sealing the first and second ends of the sealing housing, each of the end sealing assemblies including: a fastener for coupling to one of the first and second ends of the sealing housing; an elastomeric sealing member; and an end cap for directing axial load from the fastener to the corresponding elastomeric sealing member; and
cable locks that mount within the sealing housing, the cable locks being configured to clamp on strength members and/or jackets of the first and second fiber optic cables, the cable locks having outer tapers that nest with respect to inner tapers defined within the sealing housing by the sealing housing, wherein when the fasteners are coupled to the sealing housing the elastomeric sealing member are axially compressed between the end caps and the cable locks thereby causing the elastomeric sealing members to radially deform and provide sealing, and wherein when the fasteners are coupled to the sealing housing the outer tapers of the cable locks are forced against the inner tapers of the sealing housing causing the cable locks to clamp on the strength members and/or jackets of the first and second fiber optic cables.

13. The fiber optic connection system of claim 12, wherein the elastomeric sealing members have cross-sectional shapes with internal profiles that match external profiles of the cable jackets.

14. The fiber optic connection system of claim 12, wherein a threaded engagement interface is defined between the fasteners and the first and second ends of the sealing housing.

15. The fiber optic connection system of claim 12, wherein the fasteners are pre-mounted on the end caps by snapping the fasteners onto the end caps, and wherein the fasteners are rotatable relative to the end caps.

16. The fiber optic connection system of claim 12, wherein the fasteners are nuts, and a ratchet arrangement is defined between the fasteners and the end caps.

17. The fiber optic connection system of claim 12, wherein the end caps have cable strain relief protection extensions that are more flexible than main bodies of the end caps.

18. The fiber optic connection system of claim 12, wherein the end caps are keyed and non-rotatable relative to the sealing housing, and wherein the elastomeric sealing members are keyed and non-rotatable relative to the end caps.

19. The fiber optic connection system of claim 1, wherein the rear end of the first optical fiber is factory installed in a mechanical splice device for aligning the first and second optical fibers at the splice location.

20. The fiber optic connection system of claim 19, wherein the mechanical splice device attaches to the cable anchoring component.

21. The fiber optic connection system of claim 19, wherein one of the end sealing assemblies is factory installed on the first fiber optic cable.

22. The fiber optic connection system of claim 12, wherein the rear end of the first optical fiber is factory installed in a mechanical splice device for aligning the first and second optical fibers at the splice location.

23. The fiber optic connection system of claim 22, wherein the mechanical splice device attaches to one of the cable locks.

24. The fiber optic connection system of claim 22, wherein one of the end sealing assemblies is factory installed on the first fiber optic cable.
